(19) United States
(12) Patent Application Publication
(10) Pub. No.: US 2026/0219840 A1
(43) Pub. Date: Jul. 30, 2026

(54) INFORMATION PROCESSING DEVICE, INFORMATION PROCESSING METHOD, AND INFORMATION PROCESSING SYSTEM

(71) Applicant: NEC Corporation, Tokyo (JP)

(72) Inventors: Kei TAKEMURA, Tokyo (JP); Tatsuya Matsuoka, Tokyo (JP); Tsubasa Harada, Tokyo (JP)

(73) Assignee: NEC Corporation, Tokyo (JP)

(21) Appl. No.: 19/443,464

(22) Filed: Jan. 8, 2026

(30) Foreign Application Priority Data
Jan. 28, 2025 (JP) 2025-012368

(51) Int. Cl. G06F 7/544; G06F 17/16

(52) U.S. Cl. CPC G06F 7/5443; G06F 17/16

(57) ABSTRACT

An information processing device includes an acquisition unit for acquiring an observation value of a reward obtained by an action in a certain round, and a determination unit for determining, with reference to the observation value of the reward in the certain round and a predictor of the reward in a next round after the certain round, an action in the next round. This architecture applies “artificial intelligence” to improve “decision making” in sequential environments.

### INCORPORATION BY REFERENCE

This application is based upon and claims the benefit of priority from Japanese patent application No. 2025-012368, filed on Jan. 28, 2025, the disclosure of which is incorporated herein in its entirety by reference.

### TECHNICAL FIELD

The present disclosure relates to an information processing device, an information processing method, an information processing system, and a program.

### BACKGROUND ART

There is known a technique of sequentially determining an action that maximizes a total sum of rewards while observing rewards in a state where a relationship between an action and a reward is unknown.

For example, as an example of such a technique, Chi Jin et al. “Provably Efficient Reinforcement Learning with Linear Function Approximation” arXiv: 1907.05388v2 [cs.LG], Aug. 8, 2019 discloses a technique using a so-called Upper Confidence Bounds (UCB) algorithm.

### SUMMARY

However, the technique described in Chi Jin et al. “Provably Efficient Reinforcement Learning with Linear Function Approximation” arXiv: 1907.05388v2 [cs.LG], Aug. 8, 2019 has room for improvement from the viewpoint of determining a more suitable action.

An aspect of the present disclosure has been made in view of the above problems, and an example object thereof is to provide a technique capable of determining a more suitable action.

An information processing device according to one example aspect of the present disclosure includes an acquisition means for acquiring an observation value of a reward obtained by an action in a certain round, and a determination means for determining, with reference to the observation value of the reward in the certain round and a predictor of the reward in a next round after the certain round, an action in the next round.

An information processing system according to one example aspect of the present disclosure is an information processing system including an information processing device and a terminal device, in which the information processing device includes an acquisition means for acquiring an observation value of a reward obtained by an action in a certain round, and a determination means for determining, with reference to the observation value of the reward in the certain round and a predictor of the reward in a next round after the certain round, an action in the next round, and the terminal device includes an execution means for executing the action determined by the information processing device, and an observation value acquisition means for acquiring an observation value of a reward obtained by executing the action.

An information processing method executed by one or a plurality of processors according to one example aspect of the present disclosure, includes acquiring an observation value of a reward obtained by an action in a certain round, and determining, with reference to the observation value of the reward in the certain round and a predictor of the reward in a next round after the certain round, an action in the next round.

An information processing method according to one example aspect of the present disclosure is an information processing method executed by an information processing system including an information processing device and a terminal device, in which in the information processing device, one or a plurality of processors acquires an observation value of a reward obtained by an action in a certain round, and determines, with reference to the observation value of the reward in the certain round and a predictor of the reward in a next round after the certain round, an action in the next round, and in the terminal device, one or a plurality of processors executes the action determined by the information processing device, and acquires an observation value of a reward obtained by executing the action.

A program according to one example aspect of the present disclosure is a program for causing a computer to function as an information processing device, the program causing the computer to function as, an acquisition means for acquiring an observation value of a reward obtained by an action in a certain round, and a determination means for determining, with reference to the observation value of the reward in the certain round and a predictor of the reward in a next round after the certain round, an action in the next round.

According to an example aspect of the present disclosure, a more suitable action can be determined.

### BRIEF DESCRIPTION OF THE DRAWINGS

FIG. 1 is a block diagram illustrating a configuration of an information processing device according to the present disclosure;

FIG. 2 is a flowchart illustrating a flow of an information processing method according to the present disclosure;

FIG. 3 is a diagram for describing processing by the information processing device according to the present disclosure;

FIG. 4 is a block diagram illustrating a configuration of an information processing system according to the present disclosure;

FIG. 5 is a flowchart illustrating an example of a flow of processing in the information processing system according to the present disclosure;

FIG. 6 is a block diagram illustrating a configuration of the information processing system according to the present disclosure;

FIG. 7 is a flowchart illustrating an example of a flow of processing in the information processing system according to the present disclosure;

FIG. 8 is a flowchart illustrating an example of a flow of processing by the information processing device according to the present disclosure;

FIG. 9 is a diagram illustrating a display screen example by the information processing device according to the present disclosure; and

FIG. 10 is a block diagram illustrating a configuration of a computer that functions as the information processing device according to the present disclosure.

### EXAMPLE EMBODIMENT

Hereinafter, example embodiments of the present disclosure will be described. However, the present disclosure is not limited to the following exemplary example embodiments, and various modifications can be made within a scope described in the claims. For example, example embodiments obtained by appropriately combining techniques (some or all of things or methods) adopted in the following exemplary example embodiments can also be included in the scope of the present disclosure. Example embodiments obtained by appropriately omitting some of the techniques adopted in the following exemplary example embodiments can also be included in the scope of the present disclosure. Effects mentioned in the following exemplary example embodiments are examples of effects expected in the exemplary example embodiments, and do not define extension of the present disclosure. That is, example embodiments that do not achieve the effects mentioned in the following exemplary example embodiments can also be included in the scope of the present disclosure.

### First Example Embodiment

A first exemplary example embodiment that is an example of the example embodiments of the present disclosure will be described in detail with reference to the drawings. The present exemplary example embodiment is a basic form of each exemplary example embodiment to be described below. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in the drawings referred to for describing the present exemplary example embodiment may also be adopted in another exemplary example embodiment included in the present disclosure within a range in which no particular technical problem occurs.

### <Outline of Information Processing Device 1>

The information processing device 1 according to the present exemplary example embodiment is an information processing device that sequentially executes processing of,
acquiring an observation value of a reward obtained by an action in a certain round (t), and
determining an action in a next round (t+1) with reference to the observation value and a predictor of a reward in the round after the certain round. Here, determining an action may be expressed as “decision-making”, and the determined action may be expressed as “decision-making result”. Furthermore, the information processing device 1 according to the present exemplary example embodiment may be expressed as a “decision-making device” or a “sequential decision-making device”. However, this wording is not intended to limit the present exemplary example embodiment. The “decision-making result” is also referred to as an “optimization solution” or an “optimization result”.

Furthermore, in the present exemplary example embodiment, the wording “reward” may include a concept of “loss”. For example, the observation value of the reward can also be expressed as a value obtained by inverting the sign of the observation value of the loss (value obtained by multiplying the loss value by a negative constant). Therefore, the “reward” according to the present exemplary example embodiment may be replaced with a “loss”.

### (Configuration of Information Processing Device 1)

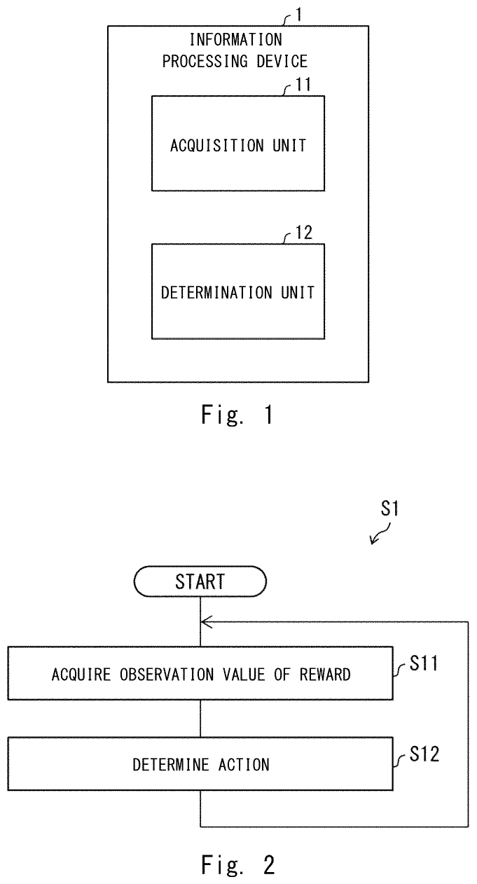

A configuration of an information processing device 1 according to the present exemplary example embodiment will be described with reference to FIG. 1. FIG. 1 is a block diagram illustrating the configuration of the information processing device 1. As illustrated in FIG. 1, the information processing device 1 includes an acquisition unit 11 and a determination unit 12.

### (Acquisition Unit 11)

The acquisition unit 11 acquires an observation value of a reward obtained by an action in a certain round t. Here, t is an index representing the number of repetitions of a round, and can also be interpreted as an index indicating timing. Therefore, it can also be expressed that the acquisition unit 11 has a configuration of sequentially acquiring the observation value of the reward obtained by the action in each round. Furthermore, the “action” refers to an action determined by the determination unit 12 described later, by way of an example. A specific example of the “action” does not limit the present exemplary example embodiment, but may include “price”, “stock amount”, and the like of the object by way of an example. Furthermore, a specific example of the “reward” does not limit the present exemplary example embodiment, but by way of example, includes “sales”, “a reciprocal of an inventory quantity”, “a value obtained by subtracting an inventory quantity from a constant”, or the like related to an object.

### (Determination Unit 12)

The determination unit 12 determines an action in the next round t+1 with reference to the observation value of the reward in the certain round t and the predictor of the reward in the round after the certain round. The determination unit 12 may be expressed as a configuration that sequentially determines the action in the next round with reference to the observation value of the reward in each round and the predictor of the reward in the next round. Here, the wording “predictor” indicates that the element can be interpreted as a prediction value in the future. However, the wording does not limit the present exemplary example embodiment, and may be expressed as an additional term, an additional contribution, a correction term, a correction contribution, or the like.

In addition, a specific example of the predictor does not limit the present exemplary example embodiment, but may be represented by using a Lovasz extension of a submodular function indicating the reward, by way of example. Furthermore, the action determined by the determination unit 12 can include, as an example, selecting 0 or 1 in n-dimensional vector in each round.

### (Effects of Information Processing Device 1)

As described above, in the information processing device 1, a configuration is adopted of,
acquiring an observation value of a reward obtained by an action in a round, and
determining an action in a next round with reference to an observation value of a reward in the certain round and a predictor of a reward in a round after the certain round. In this manner, since the information processing device 1 determines an action in the next round with reference to the predictor of a reward in the next round, a more suitable action can be determined.

### (Flow of Information Processing Method S1)

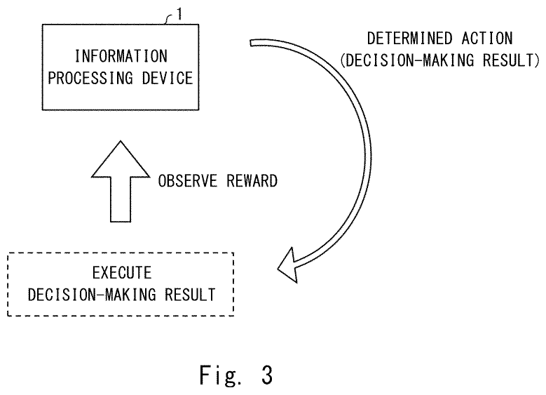

Subsequently, a flow of an information processing method S1 according to the present exemplary example embodiment will be described with reference to FIG. 2. FIG. 2 is a flowchart illustrating the flow of the information processing method S1. As illustrated in FIG. 2, the information processing method S1 includes a step (processing) S11 of acquiring an observation value of a reward and a step (processing) S12 of determining an action.

### (Step S11)

In step S11, the acquisition unit 11 acquires an observation value of the reward obtained by the action in a certain round t. Since a more specific description of the acquisition unit 11 has been described above, the description thereof will be omitted here.

### (Step S12)

In step S12, the determination unit 12 determines an action in the next round t+1 with reference to the observation value of the reward in the certain round t and the predictor of the reward in the round after the certain round. Since a more specific description of the determination unit 12 has been described above, the description thereof will be omitted here. After the processing in step S12, the index t representing the number of repetitions of the round is incremented, and the processing in step S11 is executed.

FIG. 3 is a diagram for schematically describing sequential decision-making processing by the information processing method S1 according to the present exemplary example embodiment. As illustrated in FIG. 3, the information processing device 1 determines an action in the next round with reference to an observation value of a reward in a certain round and a predictor of a reward in a round after the certain round. In other words, the information processing device 1 derives the decision-making result related to the next round with reference to the observation value of the reward in a certain round and the predictor of the reward in the round after the certain round. Then, by executing the derived decision-making result, the observation value of the reward in the next round is obtained. The observation value of the reward is provided to the information processing device 1, and is referred to in the decision-making processing in the next round. In this manner, the information processing device 1 sequentially derives the decision-making result.

### (Effects of Information Processing Method S1)

As described above, in the information processing method S1, a configuration is adopted of,
acquiring an observation value of a reward obtained by an action in a round, and
determining an action in a next round with reference to an observation value of a reward in the certain round and a predictor of a reward in a round after the certain round. According to the above configuration, an effect is provided similar to that of the information processing device 1.

### (Configuration of Information Processing System 100)

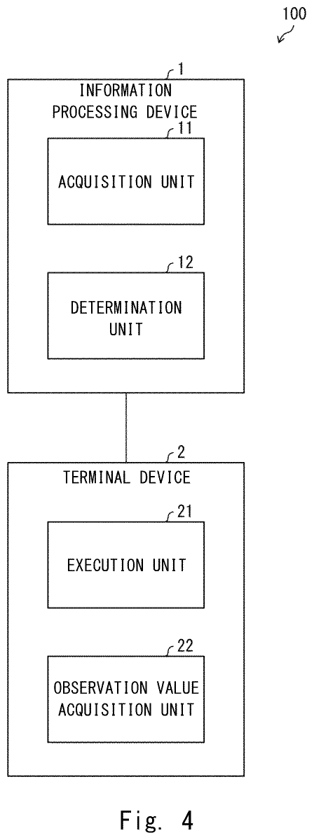

Next, a configuration of an information processing system 100 according to the present exemplary example embodiment will be described with reference to FIG. 4. FIG. 4 is a block diagram illustrating the configuration of the information processing system 100. As illustrated in FIG. 4, the information processing system 100 includes an information processing device 1 and a terminal device 2 communicably connected to each other. Since each configuration included in the information processing device 1 has been described above, description thereof is omitted here.

### (Terminal Device 2)

As illustrated in FIG. 4, the terminal device 2 includes an execution unit 21 and an observation value acquisition unit 22. The execution unit 21 executes a decision-making result derived by the information processing device 1 or processing corresponding to the decision-making result. As an example, in a case where the decision-making result is to predict X yen as today's optimal price related to a product A, the execution unit 21 associates the price X yen with the product A.

The observation value acquisition unit 22 acquires an observation value of a reward obtained as a result of executing a decision-making result derived by the information processing device 1 or processing corresponding to the decision-making result. The obtained observation value of the reward is referred to in the decision-making processing in the next round (in the case of the present example, tomorrow) in the information processing device 1.

### <Flow of Information Processing Method S100>

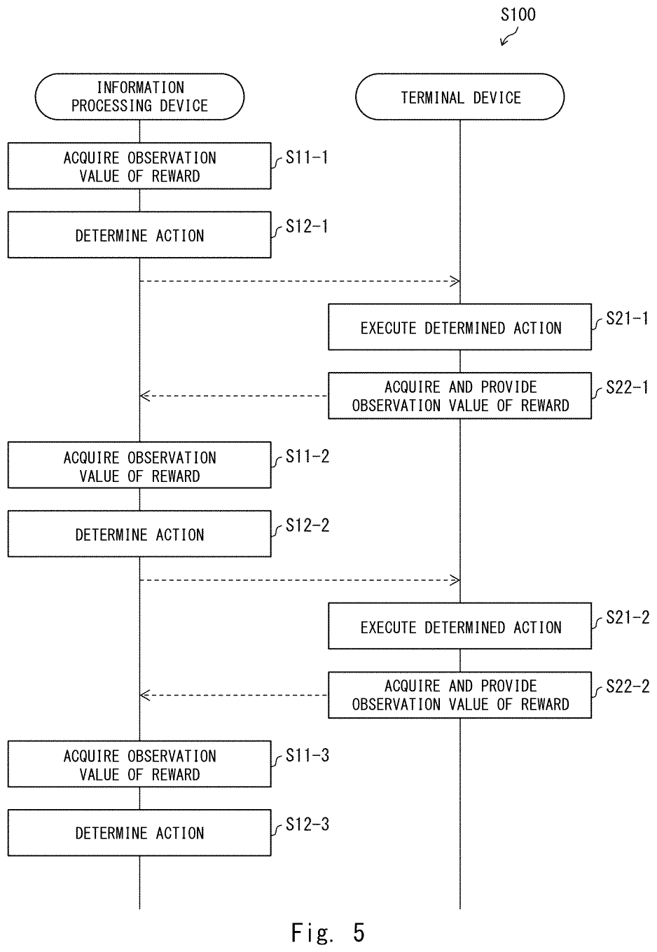

Next, a flow of an information processing method S100 according to the present first exemplary example embodiment will be described with reference to FIG. 5. FIG. 5 is a flowchart illustrating a flow of the information processing method S100 executed by the information processing system 100. Here, in the reference numerals given to each step in FIG. 5, the repetition order is described as the branch number after the hyphen “-”. For example, S11-1 represents the first repetition, and S11-2 represents the second repetition. The same applies to other steps.

### (Steps S11-1 and S12-1)

As illustrated in FIG. 4, in step S11-1, the acquisition unit 11 acquires the observation value of the reward obtained by the action in the round t=0. Then, in step S12-1, the determination unit 12 determines, with reference to the observation value of the reward in the round t=0 and the predictor of the reward in a next round after the round, an action in the next round t=1 (derives a decision-making result).

### (Steps S21-1 and S22-1)

In step S21-1, the execution unit 21 of the terminal device 2 executes the decision-making result determined in step S12-1 or processing corresponding to the decision-making result. In step S22-1, the observation value acquisition unit 22 of the terminal device 2 acquires the observation value of the reward in the round t=1 obtained as a result of the execution, and provides the observation value to the information processing device 1.

### (Steps S11-2 and S12-2)

In step S11-2, the acquisition unit 11 acquires the observation value of the reward obtained by the action in the round t=1. Then, in step S12-1, the determination unit 12 determines, with reference to the observation value of the reward in the round t=1 and the predictor of the reward in a next round t=2 after the round, an action in the next round t=2 (derives a decision-making result). The decision-making result derived in step S12-2 is provided to the terminal device 2 and executed in step S21-2.

As described above, in the information processing system 100 according to the present exemplary example embodiment,
the information processing device 1 adopts a configuration of,
acquiring an observation value of a reward obtained by an action in a round,
determining an action in a next round with reference to an observation value of a reward in the certain round and a predictor of a reward in a round after the certain round, and
the terminal device 2 adopts a configuration of,
executing an action determined by the information processing device 1, and
acquiring an observation value of a reward obtained by executing the action. As described above, in the information processing system 100, since the action in the next round is determined with reference to the predictor of the reward in the next round, a more suitable action can be determined.

### Second Example Embodiment

A second exemplary example embodiment that is an example of the example embodiments of the present disclosure will be described in detail with reference to the drawings. Components having the same functions as the components described in the above-described exemplary example embodiment are denoted by the same reference signs, and the description thereof will be appropriately omitted. An application range of each technique adopted in the present exemplary example embodiment is not limited to the present exemplary example embodiment. That is, each technique adopted in the present exemplary example embodiment can also be adopted in another exemplary example embodiment included in the present disclosure within a range in which no particular technical problem occurs. Each technique illustrated in each of the drawings referred to for describing the present exemplary example embodiment can be employed in the other exemplary example embodiments included in the present disclosure within the scope in which no particular technical problem occurs.

### (Configuration of Information Processing System 100A)

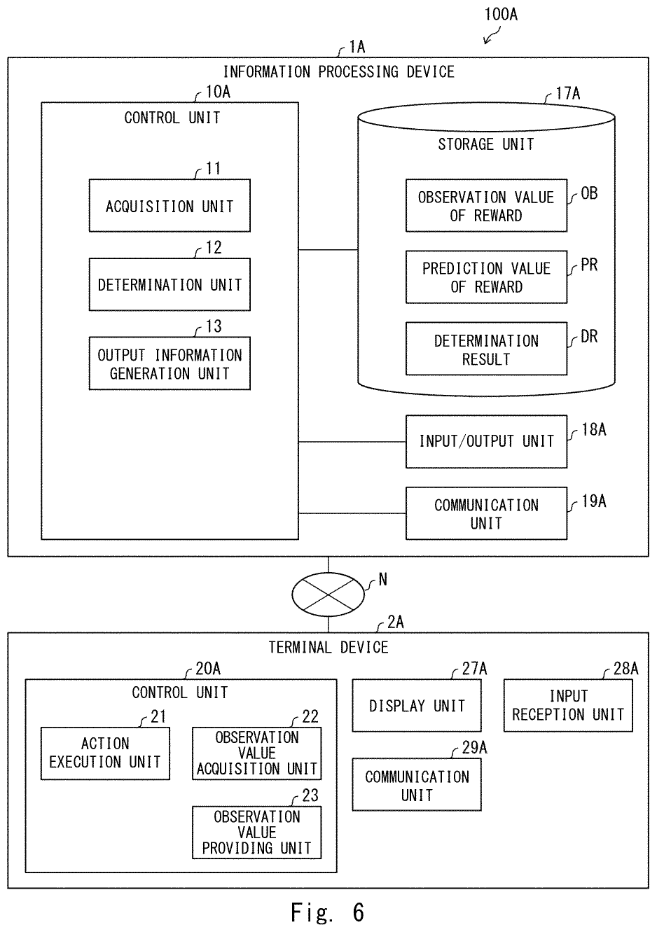

A configuration of an information processing system 100A according to the present exemplary example embodiment will be described with reference to FIG. 6. FIG. 6 is a block diagram illustrating a configuration of the information processing system 100A. As illustrated in FIG. 3, the information processing system 100A includes an information processing device 1A and a terminal device 2A connected to the information processing device 1A via a network N. Here, as a specific configuration of the network N does not limit the present exemplary example embodiment, but by way of an example, a wireless Local Area Network (LAN), a wired LAN, a Wide Area Network (WAN), a public line network, a mobile data communication network, or a combination of these networks can be used.

### (Configuration of Terminal Device 2A)

As illustrated in FIG. 6, the terminal device 2A includes a control unit 20A, a display unit 27A, an input reception unit 28A, and a communication unit 29A. The terminal device can be specifically implemented as, for example, an information processing terminal or the like disposed in a store, but this does not limit the present exemplary example embodiment.

The communication unit 29A communicates with a device outside the terminal device 2A. As an example, the communication unit 29A communicates with the information processing device 1A. The communication unit 29A transmits data supplied from the control unit 20A to the information processing device 1A, and supplies data received from the information processing device 1A to the control unit 20A.

The display unit 27A displays the display data supplied from the control unit 20A. As an example, the display unit 27A displays information indicating an action (decision-making result) determined by the determination unit 12 of the information processing device 1A and supplied to the terminal device 2A.

The input reception unit 28A receives various inputs to the terminal device 2A. As an example, the input reception unit 28A receives the observation value of the reward in each round t. Then, the received observation value is supplied to the control unit 20A. The supplied observation value is transmitted to the information processing device 1A via the communication unit 29A, and is acquired by the acquisition unit 11 of the information processing device 1A. The input reception unit 28A may be configured to receive the observation value via an operation by the user, or may be configured to automatically acquire the observation value.

The specific configuration of the input reception unit 28A is not limited to the present exemplary example embodiment, but by way of an example, the input reception unit 28A may include an input device such as a keyboard and a touch pad. Furthermore, the input reception unit 28A may include a data scanner or the like that reads data via electromagnetic waves such as infrared rays and radio waves.

### (Control Unit 20A)

As illustrated in FIG. 4, the control unit 20A includes an action execution unit 21, an observation value acquisition unit 22, and an observation value providing unit 23.

The action execution unit 21 acquires information indicating the action determined by the determination unit 12 of the information processing device 1A in each round t, and executes the action. As an example, the price of one or a plurality of products indicated by the action is updated with reference to the information indicating the action. In addition, the action execution unit 21 may be configured to generate display data indicating the action, supply the generated display data to the display unit 27A, and cause the display unit 27A to display the display data. In the case of this configuration, the user updates the price of one or a plurality of products with reference to the display data displayed by the display unit 27A.

The observation value acquisition unit 22 acquires an observation value (as an example, sales related to the one or a plurality of products) of the reward after the action execution unit 21 executes the action via the input reception unit 28. The observation value of the reward acquired by the observation value acquisition unit 22 is supplied by the observation value providing unit 23 to the information processing device 1A via the communication unit 29A, and is acquired by the acquisition unit 11 of the information processing device 1A.

### (Outline of Information Processing Device 1A)

The information processing device 1A according to the present exemplary example embodiment is, similarly to the first exemplary example embodiment, an information processing device that sequentially executes processing of,
acquiring an observation value of a reward obtained by an action in a certain round (t), and
determining an action in a next round (t+1) with reference to the observation value and a predictor of a reward in the round after the certain round. Here, in the present exemplary example embodiment as well, determining an action may be expressed as “decision-making”, and the determined action may be expressed as “decision-making result”. Furthermore, the information processing device 1A according to the present exemplary example embodiment may be expressed as a “decision-making device” or a “sequential decision-making device”. However, this wording is not intended to limit the present exemplary example embodiment. The “decision-making result” is also referred to as an “optimization solution” or an “optimization result”.

Furthermore, similarly to the first exemplary example embodiment, in the present exemplary example embodiment, the wording “reward” may include a concept of “loss”. For example, the observation value of the reward can also be expressed as a value obtained by inverting the sign of the observation value of the loss (value obtained by multiplying the loss value by a negative constant). Therefore, the “reward” according to the present exemplary example embodiment may be replaced with a “loss”.

### (Configuration of Information Processing Device 1A)

A configuration of an information processing device 1A according to the present exemplary example embodiment will be described with reference to FIG. 6.

As illustrated in FIG. 6, the information processing device 1A includes a control unit 10A, a storage unit 17A, a communication unit 19A, and an input/output unit 18A.

### (Communication Unit 19A)

The communication unit 19A communicates with a device outside the information processing device 1A. As an example, the communication unit 19A communicates with the terminal device 2A. The communication unit 19A transmits data supplied from the control unit 10A to the terminal device 2A, and supplies data received from the terminal device 2A to the control unit 10A. The data transmitted from the communication unit 19A to the terminal device 2A includes information indicating an action (decision-making result) determined by the determination unit 12 described later. Furthermore, the data received from the terminal device 2A by the communication unit 19A may include an observation value of reward obtained as a result of executing the action described above.

### (Input/Output Unit 18A)

The input/output unit 18A includes at least one of input/output devices such as a keyboard, mouse, a display, a printer, and a touch panel. Alternatively, the input/output unit 18A may be connected to an input/output device such as a keyboard, a mouse, a display, a printer, or a touch panel. In the case of this configuration, the input/output unit 18A receives inputs of various types of information to the information processing device 1A from the connected input device. Furthermore, the input/output unit 18A outputs various types of information to a connected output device under the control of the control unit 10A. Examples of the input/output unit 18A include an interface such as, for example, a Universal Serial Bus (USB).

### (Storage Unit 17A)

The storage unit 17A stores various types of data referred to by the control unit 10A and various types of data generated by the control unit 10A. As an example, in the storage unit 17A,
observation value OB of a reward in each round
prediction value PR of a reward in each round
determination result (decision-making result) DR by the determination unit 12
and the like are stored.

### (Control Unit 10A)

As illustrated in FIG. 6, the control unit 10A includes an acquisition unit 11, a determination unit 12, and an output information generation unit 13.

### (Acquisition Unit 11)

The acquisition unit 11 acquires an observation value of a reward obtained by an action in a certain round t-1. Here, similarly to the first exemplary example embodiment, tis an index representing the number of repetitions of a round, and can also be interpreted as an index indicating timing. Therefore, it can also be expressed that the acquisition unit 11 has a configuration of sequentially acquiring the observation value of the reward obtained by the action in each round. Furthermore, the “action” refers to an action determined by the determination unit 12 described later, by way of an example. Specific examples of the “action” are not intended to limit the present exemplary example embodiment, but as with the first exemplary example embodiment, include “price”, “stock amount”, and the like of the object by way of example. Furthermore, a specific example of the “reward” does not limit the present exemplary example embodiment, but by way of example, includes “sales”, “a reciprocal of an inventory quantity”, “a value obtained by subtracting an inventory quantity from a constant”, or the like related to an object.

### (Determination Unit 12)

The determination unit 12 determines an action in the next round t with reference to the observation value of the reward in the certain round t−1 and the predictor of the reward in the round after the certain round. The determination unit 12 may be expressed as a configuration that sequentially determines the action in the next round with reference to the observation value of the reward in each round and the predictor of the reward in the next round. Here, the wording “predictor” indicates that the element can be interpreted as a prediction value in the future. However, the wording does not limit the present exemplary example embodiment, and may be expressed as an additional term, an additional contribution, a correction term, a correction contribution, or the like.

In addition, a specific example of the predictor does not limit the present exemplary example embodiment, but may be represented by using a Lovasz extension of a submodular function indicating the reward, by way of example. Furthermore, the action determined by the determination unit 12 can include, as an example, selecting 0 or 1 in n-dimensional vector in each round.

More specifically, the determination processing of the action by the determination unit 12 includes, as an example, processing of determining a variable xₜ indicating the action in the round t with

$$\begin{matrix}[ Mathematical formula 1 ] & \\ \text{?} ∈ \text{?} \{ 〈 \text{?} 〉 + \text{?} ( x ) + {ψ}_{t} ( x ) \} & FORMULA 1\end{matrix}$$

$$\text{?} \text{indicates text missing or illegible when filed}$$

by using
a subgradient gₛ of a submodular function indicating the reward,
a regularization term ψₜ(x), and
fₜ₋₁(x) with a tilde, that is the Lovasz extension of a submodular function indicating the reward. Here, fₜ₋₁(x) with the tilde is an example of a predictor indicating a prediction value of a reward in the round t. The predictor indicates that the reward in the round t−1 is used as a prediction value of the reward in the round t.

However, the above example is not intended to limit the present exemplary example embodiment, and instead of using the fₜ₋₁(x) with the tilde as the predictor in the above formula 1,
Weighted average of fₜ₋₁(x) with tilde and fₜ₋₂(x) with tilde may be used. In other words, as the predictor, a weighted average of
a Lovasz extension of a submodular function indicating the reward, or fₜ₋₁ (x) with a tilde in round t−1, and
a Lovasz extension of a submodular function indicating the reward, or fₜ₋₂ (x) with a tilde in round t−2
may be used.

Here, as an example, the weighting factor used for the weighted average may be set such that a weighting factor closer to the current round has a larger value. Alternatively, the determination unit 12 may be configured to adaptively set the weighting factor according to the observation value of the reward in each round or the like. Alternatively, as the predictor, a linear combination of
a Lovasz extension of a submodular function indicating the reward, or fₜ₋₁ (x) with a tilde in round t−1, and
a predetermined constant
may be used.

The specific expression of the action determined by the determination unit 12 does not limit the present exemplary example embodiment, but as an example,
the variable xₜ is expressed as an n-dimensional vector xₜ∈[0, 1]ⁿ, and
the determination processing by the determination unit 12 may include,
processing of calculating permutation σₜ:[n]→[n] satisfying x_{tσ}(i)≤x_{tσ(i+1)} for all i∈[n−1],
random variable determination processing of determining a value of a random variable uₜ uniformly distributed on [0, 1], and
processing of determining a subset Xₜ indicating the action in such a way as to satisfy Xₜ={i∈[n]|xₜᵢ≥uₜ}. A more specific processing by the determination unit 12 will be described later.

### (Output Information Generation Unit 13)

The output information generation unit 13 generates output information including the action (decision-making result) determined by the determination unit 12. As an example, the output information generation unit 13 generates output information for display including the decision-making result, and visually presents the output information to the user via the display included in the input/output unit 18A. Alternatively, the output information generation unit 13 generates output information for transmission including the decision-making result, and provides the output information for transmission to the terminal device 2A via the communication unit 19A.

### (Flow of Processing by Information Processing System 100A)

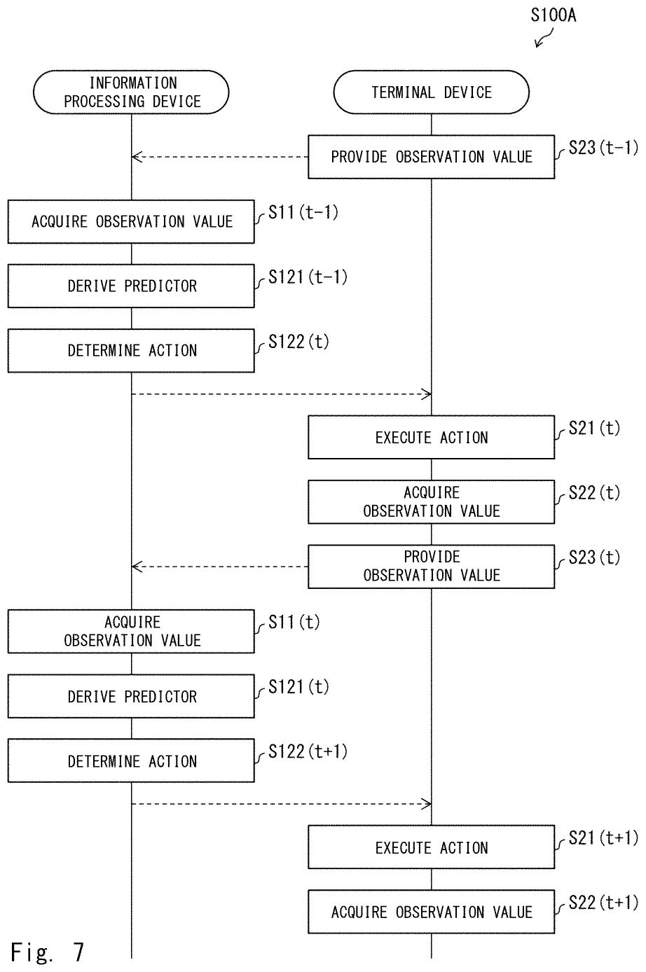

Next, a flow of an information processing method S100A by the information processing system 100A according to the present exemplary example embodiment will be described with reference to FIG. 7. In the following description, each step of the round t−1 is denoted by (t−1), each step of the round t is denoted by (t), and the like to distinguish each round.

### (Step S23(t−1))

As illustrated in FIG. 7, in step S23(t−1), the terminal device 2A provides the information processing device 1A with the observation value fₜ₋₁ of the reward. As an example, in step S23(t−1), the terminal device 2A provides an observation value fₜ₋₁(X) of the reward for any subset X∈[n].

### (Step S11(t−1))

Subsequently, in step S13(t−1), the acquisition unit 11 of the information processing device 1A acquires the observation value fₜ₋₁ of the reward provided by the terminal device 2A in step S23(t−1).

### (Step S121(t−1))

Subsequently, in step S121(t−1), the determination unit 12 of the information processing device 1A derives a predictor with reference to the observation value fₜ₋₁ of the reward acquired by the acquisition unit in step S11(t−1). Here, the predictor indicates, as an example, a prediction value of a reward in the next round t after the round t−1. As an example, the determination unit 12 sets fₜ₋₁(x) with a tilde, that is the Lovasz extension of a submodular function indicating the reward, as a predictor of the reward. More specific processing by the determination unit 12 related to this step will be described later.

### (Step S122(t−1))

Subsequently, in step S122(t−1), the determination unit 12 of the information processing device 1A determines an action in the round t with reference to: —the observation value fₜ₋₁ of the reward acquired by the acquisition unit 11 in step S11(t−1), and —the predictor derived in step S121(t−1). As an example, the determination unit 12 selects a subset xₜ∈[n] representing the action. Information indicating the selected subset xₜ∈[n] is transmitted to the terminal device 2A via the communication unit 19A.

### (Step S21(t))

Subsequently, in step S21(t), the action execution unit 21 of the terminal device 2A executes an action related to the information indicating the subset Xₜ∈[n] selected by the determination unit 12 in step S122(t). Since the specific processing by the action execution unit 21 has been described above, the description thereof will be omitted here.

### (Step S22(t))

Subsequently, in step S22(t), the observation value acquisition unit 22 of the terminal device 2A acquires the observation value of the reward obtained after the action by the action execution unit 21 in step S21(t).

### (Step S23(t))

Subsequently, in step S23(t), the terminal device 2A provides the observation value of the reward acquired in step S22(t) to the information processing device 1A.

Thereafter, as illustrated in FIG. 7, a round of executing each step described above is repeated.

### (Processing Example by Information Processing Device 1A)

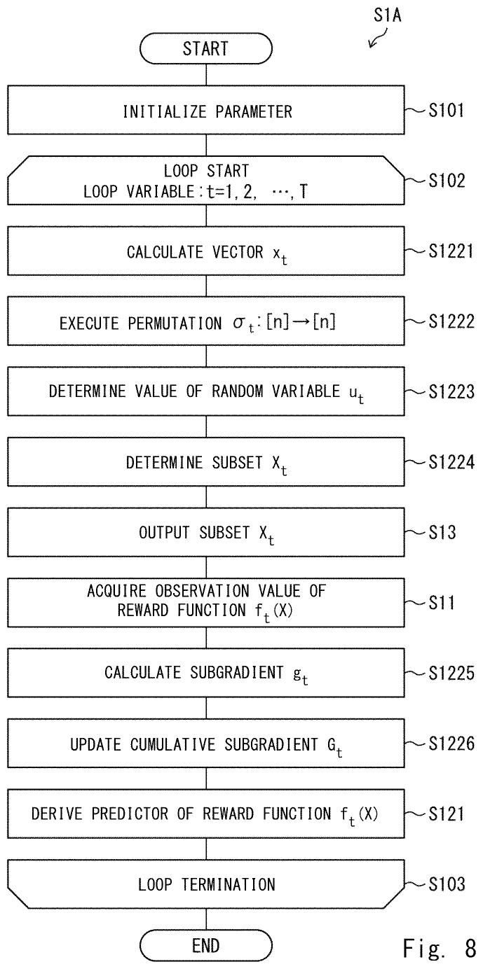

Next, a flow of a processing example by the information processing device 1A will be described with reference to FIG. 8. In the following description, steps S1221 to S1226 are examples of substeps constituting step S122 described above.

### (Step S101)

First, in step S101, the determination unit 12 initializes various parameters used for processing. As an example, the determination unit 12 initializes the cumulative subgradient G₁ in the first round as follows: G₁ᵢ=0∈Rⁿ. Here, i is an index satisfying i∈[n], and [n] is a set of natural numbers [n]=1, 2, . . . , n (n is any natural number).

### (Step S102)

Step S102 is a start of the loop processing represented by the loop variable t (t=1, 2, . . . , T) (Tis any natural number). Here, the loop variable tis an index indicating a round number.

### (Step S1221)

In step S1221, the determination unit 12 calculates a vector xₜ∈[0, 1]ⁿ representing an element of an action by,

$$\begin{matrix}[ Mathematical formula 2 ] & \\ \text{?} ∈ \text{?} \{ 〈 \text{?} 〉 + \text{?} ( x ) + {ψ}_{t} ( x ) \} & FORMULA 2\end{matrix}$$

$$\text{?} \text{indicates text missing or illegible when filed}$$

Here,

$$\begin{matrix}[ Mathematical formula 3 ] & \\ {\sum }_{s = 1}^{t - 1} \text{?} & FORMULA 3\end{matrix}$$

$$\text{?} \text{indicates text missing or illegible when filed}$$

corresponds to the cumulative subgradient Gₜ from round s=0 to round s=t−1, by way of an example. The update processing of the cumulative subgradient will be described later. Furthermore, fₜ₋₁(x) with a tilde

$$\begin{matrix}[ Mathematical formula 4 ] & \\ \text{?} ( x ) & FORMULA 4\end{matrix}$$

$$\text{?} \text{indicates text missing or illegible when filed}$$

is a Lovasz extension of the submodular function f indicating the reward, and has a meaning as a predictor indicating a prediction value of the reward in the round t.

Furthermore, in Formula 2,

$$\begin{matrix}[ Mathematical formula 5 ] & \\ \text{?} ( x ) & FORMULA 5\end{matrix}$$

$$\text{?} \text{indicates text missing or illegible when filed}$$

represents a normalization term, and as an example, is given by

$$\begin{matrix}[ Mathematical formula 6 ] & \\ {ψ}_{t} ( x ) = {\sum }_{i = 1}^{n} {λ}_{ti} ϕ ( {x}_{i} ) , & FORMULA 6\end{matrix}$$

$$ϕ ( z ) = z log z + ( 1 - z ) log ( 1 - z )$$

Here, λₜᵢ is a parameter indicating a learning rate, and is defined by the following formula as an example.

$$\begin{matrix}[ Mathematical formula 7 ] & \\ {λ}_{ti} = 2 + \frac{1}{log 2} \text{?} {λ}_{si} \cdot v ( \frac{{g}_{si}}{{λ}_{si}} , {x}_{si} ) & FORMULA 7\end{matrix}$$

$$\text{?} \text{indicates text missing or illegible when filed}$$

where v is, for all z∈[0, 1] and g∈R, defined by

$$[ Mathematical formula 8 ]$$

$$v ( g , 𝓏 ) = log ( 1 - 𝓏 + 𝓏 exp ( g ) ) - 𝓏 g \qquad FORMULA 8$$

### (Step S1222)

Subsequently, in step S1222, the determination unit 12 calculates, for all i∈[n−1],
permutation σₜ:[n]→[n]
to obtain x_{tσ(i)}≤x_{tσ(i+1)}.

### (Step S1223)

Subsequently, in step S1223, the determination unit 12 determines the value of the random variable uₜ uniformly distributed on [0, 1]. In other words, the determination unit 12 determines the value of the variable uₜ according to the uniform probability distribution on [0, 1].

### (Step S1224)

Subsequently, in step S1224, the determination unit 12 calculates the subset Xₜ in such a way as to satisfy
Xₜ={i∈[n]|xₜᵢ≥uₜ}. The subset Xₜ expresses the action (decision-making result) determined by the determination unit 12.

### (Step S13)

Subsequently, in step S13, the output information generation unit 123 generates output information including the subset Xₜ selected by the determination unit 12 in step S1224. The generated output information is supplied to the terminal device 2A as an example, and an action associated with the subset Xₜ is executed in the environment on the terminal device 2A side.

### (Step S11)

Subsequently, in step S11, the acquisition unit 11 acquires the observation value fₜ(X) of the reward. In this step, as an example, the acquisition unit 11 can acquire an observation value fₜ(X) of a reward for any subset X∈[n], the observation value of the reward being obtained after the output information including the subset Xₜ is output by the output information generation unit 13 in step S13.

### (Step S1225)

Subsequently, in step S1225, the determination unit 12 calculates the subgradient gₜ∈R^{d} by

$$[ Mathematical formula 9 ]$$

$${g}_{t} = {h}_{t} ( {σ}_{t} ) = {\sum }_{i = 0}^{n} {f}_{t} ( {σ}_{t} ( [ i ] ) ) {ρ}_{i} ( {σ}_{t} ) \qquad FORMULA 9$$

Here, ρᵢ(σₜ) is defined by:

$$[ Mathematical formula 10 ]$$

$${ρ}_{i} ( σ ) = \{ \begin{matrix}{χ}_{σ ( i )} & i = 0 \\ {χ}_{σ ( i + 1 )} - {χ}_{σ ( i )} & i ∈ [ n - 1 ] \\ - {χ}_{σ ( n )} & i = n\end{matrix} \qquad FORMULA 10$$

where χᵢ∈{0, 1}ⁿ represents an indicator vector of i, and only if i=j, χᵢⱼ=1.

### (Step S1226)

Subsequently, in step S1226, the determination unit 12 updates the cumulative subgradient Gₜ by

Gₜ₊₁=Gₜ+gₜ. More specifically, in this step, the determination unit 12 updates the cumulative subgradient Gₜ expressed by

$$[ Mathematical formula 11 ]$$

$${G}_{t} = {\sum }_{s = 1}^{t - 1} {g}_{s} = {\sum }_{s = 1}^{t - 1} {h}_{s} ( {σ}_{s} ) \qquad FORMULA 11$$

$$by$$

$${G}_{t +} 1 = {G}_{t} + {g}_{t} .$$

### (Step S121)

Subsequently, in step S121, the determination unit 12 derives a predictor of the reward function fₜ(X). As an example, the determination unit 12 sets the predictor of the reward fₜ(X) in the round t as the Lovasz extension of the submodular function f indicating the reward in the round t−1.

$$[ Mathematical formula 12 ]$$

$${\tilde{f}}_{t - 1} ( x ) \qquad FORMULA 12$$

This indicates that the Lovasz extension of the submodular function f indicating the reward in the round t−1 is used as a predictor indicating the prediction value of the reward in the round t. The setting of the predictor is not limited to the above example as described above.

### (Step S103)

Step S103 is the termination of the loop processing represented by the loop variable t.

As described above, in the determination processing by the determination unit 12, as an example,
the variable xₜ is an n-dimensional vector xₜ∈[0, 1]ⁿ, and
the determination processing includes,
processing (step S1222) of calculating permutation σₜ: [n]→[n] satisfying x_{tσ}(i)≤x_{tσ(i+1)} for all i∈[n−1],
random variable determination processing (step S1223) of determining values of the random variable uₜ uniformly distributed on [0, 1], and
processing (step S1224) of determining a subset xₜ indicating the action in such a way as to satisfy xₜ={i∈[n]|xₜᵢ>uₜ}.

Furthermore, as described above, the determination processing by the determination unit 12 includes processing (step S1225) of calculating the subgradient gₜ with reference to the observation value of the submodular function fₜ acquired by the acquisition unit 11 that indicates the reward, and processing (step S121) of calculating fₜ(x) with a tilde that is a Lovasz extension of the submodular function.

(Relationship with Lovasz Extension)

Hereinafter, a relationship between the above-described processing example and the Lovasz extension will be described.

If function f: 2^{[n]}→R
is given, the Lovasz extension of the function f is given as,
~f: [0, 1]n→R. Here, “~f” represents “f” with a tilde.

First, for

$$x = {( {x}_{1} , {x}_{2} , {x}_{n} )}^{T} ∈ {[ 0 , 1 ]}^{n}$$

$$and$$

$$u ∈ [ 0 , 1 ]$$

a set of indices i satisfying xᵢ≥u is represented as Hᵤ(x). That is, Hᵤ(x) is defined by,
Hᵤ(x)={i∈[n]|xᵢ≥u}. Using this Hᵤ(x), the Lovasz extension ~f(x) is defined by,

$$[ Mathematical formula 13 ]$$

$$\tilde{f} ( x ) = {E}_{u \sim Unif ( [ 0 , 1 ] )} [ f ( {H}_{u} ( x ) ) ] \qquad FORMULA 13$$

Here, Unif([0, 1]) represents a uniform distribution on [0, 1]. It is known that the Lovasz extension ~f(x) is a convex function only if the function f is submodular.

From the above definition, for any x∈[0, 1]ⁿ and for any i∈[n−1], the Lovasz extension ~f(x) is given by:

$$[ Mathematical formula 14 ]$$

$$\tilde{f} ( x ) = {\sum }_{i = 0}^{n} ( {x}_{σ ( i + 1 )} - {x}_{σ ( i )} ) f ( σ ( [ i ] ) ) \qquad FORMULA 14$$

with respect to any permutation σ: [n]→[n] satisfying x_{σ(i)}≤x_{σ(i+1)}. Here, σ[i]={σ(j)|j∈[i]}, and exceptionally, x_{σ(0)}=0 and x_{σ(n+1)}=1 are defined.

Thus, the subgradient g(σ)∈Rⁿ of the Lovasz extension ~f(x) is defined by:

$$[ Mathematical formula 15 ]$$

$${g}_{t} = {h}_{t} ( {σ}_{t} ) = {\sum }_{i = 0}^{n} {f}_{t} ( {σ}_{i} ( [ i ] ) ) {ρ}_{i} ( {σ}_{t} ) \qquad FORMULA 15$$

Here, ρᵢ(σ) is as described in the above processing example.

### (Effects of Information Processing Device 1A)

As described above, the information processing device 1A in the present exemplary example embodiment adopts a configuration of,
acquiring an observation value of a reward obtained by an action in a certain round, and
determining an action in a next round with reference to an observation value of a reward in the certain round and a predictor of a reward in a round after the certain round. In this manner, since the information processing device 1A determines an action in the next round with reference to the predictor of a reward in the next round, a more suitable action can be determined. Furthermore, in the information processing device 1A, since a function obtained by a Lovasz extension of a submodular function indicating the reward is used as the predictor, the predictor can be suitably set.

### (Example of Problem Setting in Information Processing Device 1A)

A simple example of the problem setting example and the processing example in the information processing device 1A is as follows, but the following example is of course not intended to limit the present exemplary example embodiment.

### (Problem Setting)

Consider a case of n=1 (in other words, a problem of selecting one type of 0 or 1).
Loss (the sign of the reward is inverted) is always fₜ(x)=−x (i.e., x=1 is the best). Here, x is one-dimensional and a real number.
Subgradient is −1.

### (Processing and Effects Corresponding to Problem Setting by Information Processing Device 1A)

As it reduces to the online convex optimization, a probability of selecting x=1 is considered.
The predictor in the information processing device 1A is always −1 (other than the first one).
According to the information processing device 1A, the probability of selecting x=1 increases by the number of predictors as compared with a configuration in which a predictor is not used.

### (Display Example by Information Processing System 100A)

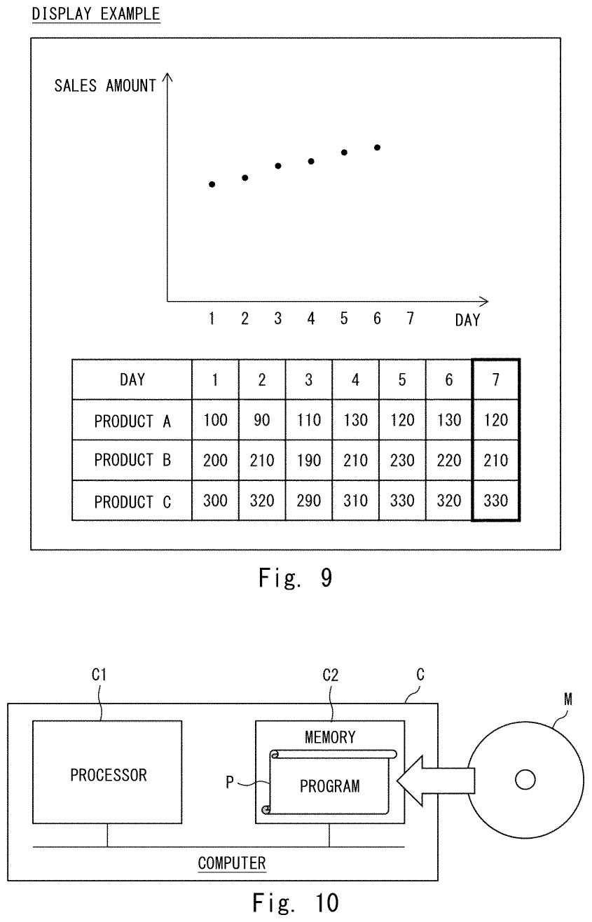

Next, a display example by the information processing system 100A will be described with reference to FIG. 9. FIG. 9 is a diagram illustrating a display example by the information processing system 100A. The example illustrated in FIG. 9 is a display example in a case where a function indicating (the sum of) sales amounts of a plurality of products is used as a function indicating a reward (hereinafter also referred to as an objective function) and one round is set as one day. That is, in the example illustrated in FIG. 9, the determination unit 12 of the information processing device 1A selects the subset Xₜ on a certain day (round t) with reference to the observation value (sales amount) of the objective function up to the day before the certain day (round t−1) and the predictor indicating the prediction value of the sales amount on the certain day (round t).

Then, as illustrated in FIG. 9, the display unit 27A of the terminal device 2A displays each observation value (sales amount in FIG. 9) of the objective function for each round (day in FIG. 9). Furthermore, in the example illustrated in FIG. 9, the display unit 27A of the terminal device 2A displays information regarding the subset selected in the round t (the price of the products A to C).

The information processing system 100A can present the sales amount and the price of the product to the user by performing such display.

### Application Example

The information processing devices 1 and 1A described above can be applied to various problems. An example thereof will be described below.

### (Minimum Time Path Problem)

It is assumed that selection of a path from one point to another point is an action. For example, it is assumed that there are n−1 relay points from one point to another point, and m selectable paths exist in each section. In a case of the action measure (selected subset) Xₜ=[0, 2, 1, . . . ] in such a situation, it indicates that path 0 is selected in the first section, path 2 is selected in the second section, and path 1 is selected in the third section.

The objective function fₜ has the action measure Xₜ as an input and the time required to pass through the path indicated by the action measure as an output. In this case, by applying the above-described optimization method, it is possible to derive optimal path setting for reaching from one point to another point in as short as possible time.

### (Retail)

It is assumed that a discount of a price of beer of each company at a certain store is taken as an action. For example, in a case where the action measure (selected subset) is Xₜ=[0, 2, 1, . . . ], it is assumed that the first element indicates a beer price of A company as a fixed price, the second element indicates a beer price of B company as a 10% premium, and the third element indicates a beer price of C company as a 10% discount from the fixed price.

The objective function fₜ has the action measure Xₜ as an input and a result of sales performed by applying the action measure X to the price of beer of each company as an output. In this case, by applying the above-described optimization method, it is possible to derive optimum price setting of beer prices of each company in the store.

### (Investment Portfolio)

A case of being applied to investment behavior by an investor or the like will be described. In this case, investment (purchase, capital increase), sale, and holding with respect to a plurality of financial products (names of stocks etc.) held or intended to be held by the investor are defined as the action measure Xₜ. For example, in a case where the action measure (selected subset) is Xₜ=[1, 0, 2, . . . ], it is assumed that the first element indicates additional investment to the stocks of the company A, the second element indicates holding (neither purchasing nor selling) of the bonds of the company B, and the third element indicates selling of the stock of the company C.

Then, the objective function fₜ has the action measure xₜ as an input, and a result of applying the action measure Xₜ to the investment behavior for the financial product of each company as an output. In this case, by applying the above-described optimization method, it is possible to derive the optimal investment behavior of the investor for each name.

### (Trial Case)

A case where the present disclosure is applied to a medication behavior for a drug trial case in a pharmaceutical company will be described. In this case, the amount of medication or avoidance of medication is defined as the action measure Xₜ. For example, in a case where the action measure (selected subset) is Xₜ=[1, 0, 2, . . . ], the first element indicates that the subject A is to be dosed with amount 1, the second element indicates that the subject B is not to be medicated, and the third element indicates that the subject C is to be dosed with amount 2.

The objective function fₜ has an action measure Xₜ as an input, and the result of applying the action measure Xₜ to the medication behavior for each subject as an output. In this case, by applying the above-described optimization method, the optimal medication behavior for each subject in the trial case in the pharmaceutical company can be derived.

### (Web Marketing)

A case of being applied to advertisement behavior (marketing measures) in an operating company of a certain e-commerce site will be described. In this case, an advertisement (online (banner) advertisement, advertisement by e-mail, direct mail, e-mail transmission of discount coupon, etc.) for a plurality of customers with respect to a product or a service to be sold by the operating company is set as the action measure Xₜ. For example, in a case where the action measure (selected subset) is Xₜ=[1, 0, 2, . . . ], the first element indicates a banner advertisement for the customer A, the second element indicates no advertisement for the customer B, and the third element indicates e-mail transmission of a discount coupon to the customer C.

The objective function fₜ has an action measure Xₜ as an input, and the result of applying the action measure Xₜ to the advertisement action for each customer as an output. Here, the execution result may be whether the banner advertisement has been clicked, a purchase amount, a purchase probability, or an expected value of the purchase amount. In this case, by applying the optimization method of the present example embodiment, it is possible to derive an optimal advertisement action for each customer in the operating company.

### [Implementation Example by Software]

The control blocks (in particular, the acquisition unit 11 and the determination unit 12) of the information processing devices 1 and 1A and the terminal devices 2 and 2A may be implemented by a logic circuit (hardware) formed in an integrated circuit (IC chip) or the like, or may be implemented by software.

In the latter case, each of the above devices is achieved by, for example, a computer that executes commands of a program that is software for implementing each function. An example of such a computer (hereinafter referred to as a computer C) is illustrated in FIG. 10. FIG. 10 is a block diagram illustrating a hardware configuration of the computer C functioning as each of the above devices.

The computer C includes at least one processor C1 and at least one memory C2. A program P for causing the computer C to operate as each of the above devices is recorded in the memory C2. In the computer C, by the processor C1 reading the program P from the memory C2 and executing the program P, each of the functions of each of the above devices is achieved.

As the processor C1, for example, a Central Processing Unit (CPU), a Graphic Processing Unit (GPU), a Digital Signal Processor (DSP), a Micro Processing Unit (MPU), a Floating point number Processing Unit (FPU), a Physics Processing Unit (PPU), a Tensor Processing Unit (TPU), a quantum processor, a microcontroller, or a combination thereof, or the like can be used. As the memory C2, for example, a flash memory, a Hard Disk Drive (HDD), a Solid State Drive (SSD), or a combination thereof, or the like can be used.

The computer C may further include a Random Access Memory (RAM) for loading the program P at the time of execution and temporarily storing various types of data. The computer C may further include a communication interface for exchanging data with another device. The computer C may further include an input/output interface for connecting input/output devices such as a keyboard, a mouse, a display, and a printer.

The program P can be recorded on a non-transitory tangible recording medium M readable by the computer C. Examples of such a recording medium M may include, for example, a tape, a disk, a card, a semiconductor memory, and a programmable logic circuit.

The computer C may acquire the program P via such a recording medium M. Furthermore, the program P may be transmitted via a transmission medium. Examples of such a transmission medium may include, for example, a communication network and a broadcast wave. The computer C may also obtain the program P via such a transmission medium.

Each of the above functions of each of the above devices may be implemented by a single processor provided in a single computer, may be implemented in cooperation by a plurality of processors provided in a single computer, or may be implemented in cooperation by a plurality of processors provided in each of a plurality of computers. The program for causing each of the above devices to implement each of the above functions may be stored in a single memory provided in a single computer, may be stored in a distributed manner in a plurality of memories provided in a single computer, or may be stored in a distributed manner in a plurality of memories provided in each of a plurality of computers.

### Supplementary Information A

The present disclosure includes the techniques described in the following supplementary notes. However, the present disclosure is not limited to the techniques described in the following supplementary notes, and various modifications can be made within the scope described in the claims.

### Supplementary Note A1

An information processing device including,
an acquisition means for acquiring an observation value of a reward obtained by an action in a certain round, and
a determination means for determining, with reference to the observation value of the reward in the certain round and a predictor of the reward in a next round after the certain round, an action in the next round.

### Supplementary Note A2

The information processing device according to supplementary note A1, in which the predictor is represented using a Lovasz extension of a submodular function indicating the reward.

### Supplementary Note A3

The information processing device according to supplementary note A2, in which determination processing by the determination means includes processing of determining a variable xₜ indicating the action in a round t by

$$[ Mathematical formula 16 ]$$

$${x}_{t} ∈ {arg min}_{x ∈ Ω} \{ 〈 x , {\sum }_{s = 1}^{t - 1} {g}_{s} 〉 + {\tilde{f}}_{t - 1} ( x ) + {ψ}_{t} ( x ) \}$$

by using
   a subgradient gₛ of the submodular function indicating the reward,
   a regularization term ψₜ(x), and
   fₜ₋₁(x) with a tilde, that is the Lovasz extension of the submodular function indicating the reward.

### Supplementary Note A4

The information processing device according to supplementary note A3, in which
the variable xₜ is an n-dimensional vector xₜ∈[0, 1]ⁿ, and
the determination processing includes,
processing of calculating permutation σt: [n]→[n] satisfying x_{tσ(i)}≤x_{tσ(i+1)} for all i∈[n−1],
random variable determination processing of determining values of a random variable uₜ uniformly distributed on [0, 1], and
processing of determining a subset Xₜ indicating the action to satisfy Xₜ={i∈[n]|xₜᵢ≥uₜ}.

### Supplementary Note A5

The information processing device according to supplementary note A4, in which the determination processing includes processing of calculating, with reference to an observation value of a submodular function fₜ acquired by the acquisition means that indicates the reward, the subgradient gₜ and fₜ(x) with a tilde that is a Lovasz extension of the submodular function.

### Supplementary Note A6

The information processing device according to any one of supplementary notes A1 to A5, in which the action determined by the determination means includes selecting 0 or 1 in n-dimensional vector in each round.

### Supplementary Note A7

An information processing system including an information processing device and a terminal device, in which
the information processing device includes,
an acquisition means for acquiring an observation value of a reward obtained by an action in a certain round, and
a determination means for determining, with reference to the observation value of the reward in the certain round and a predictor of the reward in a next round after the certain round, an action in the next round, and
the terminal device includes,
an execution means for executing the action determined by the information processing device, and
an observation value acquisition means for acquiring an observation value of a reward obtained by executing the action.

### Supplementary Information B

The present disclosure includes the techniques described in the following supplementary notes. However, the present disclosure is not limited to the techniques described in the following supplementary notes, and various modifications can be made within the scope described in the claims.

### Supplementary Note B1

An information processing method including,
acquisition processing in which at least one processor acquires an observation value of a reward obtained by an action in a certain round, and
determination processing in which the at least one processor determines, with reference to the observation value of the reward in the certain round and a predictor of the reward in a next round after the certain round, an action in the next round.

### Supplementary Note B2

The information processing method according to supplementary note B1, in which the predictor is represented using a Lovasz extension of a submodular function indicating the reward.

### Supplementary Note B3

The information processing method according to supplementary note B2, in which the determination processing includes processing of determining a variable xₜ indicating the action in a round t by

$$[ Mathematical formula 17 ]$$

$${x}_{t} ∈ {arg min}_{x ∈ Ω} \{ 〈 x , {\sum }_{s = 1}^{t - 1} {g}_{s} 〉 + {\tilde{f}}_{t - 1} ( x ) + {ψ}_{t} ( x ) \}$$

by using
   a subgradient gₛ of the submodular function indicating the reward,
   a regularization term ψₜ(x), and
   fₜ₋₁(x) with a tilde, that is the Lovasz extension of the submodular function indicating the reward.

### Supplementary Note B4

The information processing method according to supplementary note B3, in which
the variable xₜ is an n-dimensional vector xₜ∈[0, 1]ⁿ, and
the determination processing includes,
processing in which the at least one processor calculates permutation σt: [n]→[n] satisfying x_{tσ(i)}≤x_{tσ(i+1)} for all i∈[n−1],
random variable determination processing in which the at least one processor determines values of a random variable uₜ uniformly distributed on [0, 1], and
processing in which the at least one processor determines a subset Xₜ indicating the action to satisfy Xₜ={i∈[n]|xₜᵢ≥uₜ}.

### Supplementary Note B5

The information processing method according to supplementary note B4, in which the determination processing includes processing of calculating, with reference to an observation value of a submodular function fₜ acquired by the acquisition processing that indicates the reward, the subgradient gₜ and fₜ(x) with a tilde that is a Lovasz extension of the submodular function.

### Supplementary Note B6

The information processing method according to any one of supplementary notes B1 to B5, in which the action determined by the determination processing includes selecting 0 or 1 in n-dimensional vector in each round.

### Supplementary Note B7

An information processing method executed by an information processing system including an information processing device and a terminal device, in which
in the information processing device,
at least one processor acquires an observation value of a reward obtained by an action in a certain round, and
the at least one processor determines, with reference to the observation value of the reward in the certain round and a predictor of the reward in a next round after the certain round, an action in the next round, and
in the terminal device,
at least one processor executes the action determined by the information processing device, and
the at least one processor acquires an observation value of a reward obtained by executing the action.

### Supplementary Information C

The present disclosure includes the techniques described in the following supplementary notes. However, the present disclosure is not limited to the techniques described in the following supplementary notes, and various modifications can be made within the scope described in the claims.

### Supplementary Note C1

An information processing program for causing a computer to function as an information processing device, the program causing the computer to function as
an acquisition means for acquiring an observation value of a reward obtained by an action in a certain round, and
a determination means for determining, with reference to the observation value of the reward in the certain round and a predictor of the reward in a next round after the certain round, an action in the next round.

### Supplementary Note C2

The information processing program according to supplementary note C1, in which the predictor is represented using a Lovasz extension of a submodular function indicating the reward.

### Supplementary Note C3

The information processing program according to supplementary note C2, in which determination processing by the determination means includes processing of determining a variable xₜ indicating the action in a round t by

$$[ Mathematical formula 18 ]$$

$${x}_{t} ∈ {arg min}_{x ∈ Ω} \{ 〈 x , {\sum }_{s = 1}^{t - 1} {g}_{s} 〉 + {\tilde{f}}_{t - 1} ( x ) + {ψ}_{t} ( x ) \}$$

by using
   a subgradient gₛ of the submodular function indicating the reward,
   a regularization term ψₜ(x), and
   fₜ₋₁(x) with a tilde, that is the Lovasz extension of the submodular function indicating the reward.

### Supplementary Note C4

The information processing program according to supplementary note C3, in which
the variable xₜ is an n-dimensional vector xₜ∈[0, 1]ⁿ, and
the determination processing includes,
processing of calculating permutation σt: [n]→[n] satisfying x_{tσ(i)}≤x_{tσ(i+1)} for all i∈[n−1],
random variable determination processing of determining values of a random variable uₜ uniformly distributed on [0, 1], and
processing of determining a subset Xₜ indicating the action to satisfy Xₜ={i∈[n]|xₜᵢ≥uₜ}.

### Supplementary Note C5

The information processing program according to supplementary note C4, in which the determination processing includes processing of calculating, with reference to an observation value of a submodular function fₜ acquired by the acquisition means that indicates the reward, the subgradient gₜ and fₜ(x) with a tilde that is a Lovasz extension of the submodular function.

### Supplementary Note C6

The information processing program according to any one of supplementary notes C1 to C5, in which the action determined by the determination means includes selecting 0 or 1 in n-dimensional vector in each round.

### Supplementary Information D

The present disclosure includes the techniques described in the following supplementary notes. However, the present disclosure is not limited to the techniques described in the following supplementary notes, and various modifications can be made within the scope described in the claims.

### Supplementary Note D1

An information processing device including at least one processor, in which the at least one processor executes,
acquisition processing of acquiring an observation value of a reward obtained by an action in a certain round, and
determination processing of determining, with reference to the observation value of the reward in the certain round and a predictor of the reward in a next round after the certain round, an action in the next round.

The information processing device may further include a memory. The memory may store a program for causing the at least one processor to execute each of the processing.

### Supplementary Note D2

The information processing device according to supplementary note D1, in which the predictor is represented using a Lovasz extension of a submodular function indicating the reward.

### Supplementary Note D3

The information processing device according to supplementary note D2, in which the determination processing includes processing of determining a variable xₜ indicating the action in a round t by

$$[ Mathematical formula 19 ]$$

$${x}_{t} ∈ {arg min}_{x ∈ Ω} \{ 〈 x , {\sum }_{s = 1}^{t - 1} {g}_{s} 〉 + {\tilde{f}}_{t - 1} ( x ) + {ψ}_{t} ( x ) \}$$

by using
   a subgradient gₛ of the submodular function indicating the reward,
   a regularization term ψₜ(x), and
   fₜ₋₁(x) with a tilde, that is the Lovasz extension of the submodular function indicating the reward.

### Supplementary Note D4

The information processing device according to supplementary note D3, in which
the variable xₜ is an n-dimensional vector xₜ∈[0, 1]ⁿ, and
the determination processing includes,
processing of calculating permutation σt: [n]→[n] satisfying x_{tσ(i)}≤x_{tσ(i+1)} for all i∈[n−1],
random variable determination processing of determining values of a random variable uₜ uniformly distributed on [0, 1], and
processing of determining a subset Xₜ indicating the action to satisfy Xₜ={i∈[n]|xₜᵢ>uₜ}.

### Supplementary Note D5

The information processing device according to supplementary note D4, in which the determination processing includes processing of calculating, with reference to an observation value of a submodular function fₜ acquired by the acquisition processing that indicates the reward, the subgradient gₜ and fₜ(x) with a tilde that is a Lovasz extension of the submodular function.

### Supplementary Note D6

The information processing device according to any one of supplementary notes D1 to D5, in which the action determined by the determination processing includes selecting 0 or 1 in n-dimensional vector in each round.

### Supplementary Note D7

An information processing system including an information processing device and a terminal device, in which
the information processing device includes at least one processor, the at least one processor executing,
acquisition processing of acquiring an observation value of a reward obtained by an action in a certain round, and
determination processing of determining, with reference to the observation value of the reward in the certain round and a predictor of the reward in a next round after the certain round, an action in the next round, and
the terminal device includes at least one processor, the at least one processor executing,
execution processing of executing the action determined by the information processing device, and
observation value acquisition processing of acquiring an observation value of a reward obtained by executing the action.

### Supplementary Information E

The present disclosure includes the techniques described in the following supplementary notes. However, the present disclosure is not limited to the techniques described in the following supplementary notes, and various modifications can be made within the scope described in the claims.

### Supplementary Note E1

A non-transitory recording medium recorded with an information processing program for causing a computer to function as an information processing device, the program causing the computer to execute,
acquisition processing of acquiring an observation value of a reward obtained by an action in a certain round, and
determination processing of determining, with reference to the observation value of the reward in the certain round and a predictor of the reward in a next round after the certain round, an action in the next round.

1. An information processing device comprising:
a processor programmed to function as:
an acquisition unit configured to acquire an observation value of a reward obtained by an action in a certain round; and
a determination unit configured to determine, with reference to the observation value of the reward in the certain round and a predictor of the reward in a next round after the certain round, an action in the next round.

2. The information processing device according to claim 1, wherein the predictor is represented using a Lovasz extension of a submodular function indicating the reward.

3. The information processing device according to claim 2, wherein determination processing by the determination unit includes processing of determining a variable xₜ indicating the action in a round t by
$$[ Mathematical formula 1 ]$$
$${x}_{t} ∈ {arg min}_{x ∈ Ω} \{ 〈 x , {\sum }_{s = 1}^{t - 1} {g}_{s} 〉 + {\tilde{f}}_{t - 1} ( x ) + {ψ}_{t} ( x ) \}$$
by using
a subgradient gₛ of the submodular function indicating the reward,
a regularization term ψₜ(x), and
fₜ₋₁(x) with a tilde, that is the Lovasz extension of the submodular function indicating the reward.

4. The information processing device according to claim 3, wherein
the variable xₜ is an n-dimensional vector xₜ∈[0, 1]ⁿ, and
the determination processing includes,
processing of calculating permutation σt: [n]→[n] satisfying x_{tσ(i)}≤x_{tσ(i+1)} for all i∈[n−1],
random variable determination processing of determining values of a random variable uₜ uniformly distributed on [0, 1], and
processing of determining a subset Xₜ indicating the action to satisfy Xₜ={i∈[n]|xₜᵢ≥uₜ}.

5. The information processing device according to claim 4, wherein the determination processing includes processing of calculating, with reference to an observation value of a submodular function fₜ acquired by the acquisition unit that indicates the reward, the subgradient gₜ and fₜ(x) with a tilde that is a Lovasz extension of the submodular function.

6. The information processing device according to claim 1, wherein the action determined by the determination unit includes selecting 0 or 1 in n-dimensional vector in each round.

7. An information processing system including an information processing device and a terminal device, wherein
the information processing device includes,
a processor programmed to function as:
an acquisition unit configured to acquire an observation value of a reward obtained by an action in a certain round, and
a determination unit configured to determine, with reference to the observation value of the reward in the certain round and a predictor of the reward in a next round after the certain round, an action in the next round; and
the terminal device includes,
a processor programmed to function as:
an execution unit configured to execute the action determined by the information processing device, and
an observation value acquisition unit configured to acquire an observation value of a reward obtained by executing the action.

8. An information processing method executed by one or a plurality of processors, the method including,
acquiring an observation value of a reward obtained by an action in a certain round, and
determining, with reference to the observation value of the reward in the certain round and a predictor of the reward in a next round after the certain round, an action in the next round.

9. The information processing method according to claim 8, in which the predictor is represented using a Lovasz extension of a submodular function indicating the reward.

10. The information processing method according to claim 9, in which the determination processing includes processing of determining a variable xₜ indicating the action in a round t by
$$[ Mathematical formula 17 ]$$
$${x}_{t} ∈ {arg min}_{x ∈ Ω} \{ 〈 x , {\sum }_{s = 1}^{t - 1} {g}_{s} 〉 + {\tilde{f}}_{t - 1} ( x ) + {ψ}_{t} ( x ) \}$$
by using
a subgradient gₛ of the submodular function indicating the reward,
a regularization term ψₜ(x), and
fₜ₋₁(x) with a tilde, that is the Lovasz extension of the submodular function indicating the reward.

11. The information processing method according to claim 10, in which
the variable xₜ is an n-dimensional vector xₜ∈[0, 1]ⁿ, and
the determination processing includes,
processing in which the at least one processor calculates permutation σt: [n]→[n] satisfying x_{tσ(i)}≤x_{tσ(i+1)} for all i∈[n−1],
random variable determination processing in which the at least one processor determines values of a random variable uₜ uniformly distributed on [0, 1], and
processing in which the at least one processor determines a subset Xₜ indicating the action to satisfy Xₜ={i∈[n]|xₜᵢ≥uₜ}.

12. The information processing method according to claim 11, in which the determination processing includes processing of calculating, with reference to an observation value of a submodular function fₜ acquired by the acquisition processing that indicates the reward, the subgradient gₜ and fₜ(x) with a tilde that is a Lovasz extension of the submodular function.

13. The information processing method according to claim 8, in which the action determined by the determination processing includes selecting 0 or 1 in n-dimensional vector in each round.
